(19) United States
(12) Patent Application Publication
(10) Pub. No.: US 2017/0178442 A1
(43) Pub. Date: Jun. 22, 2017

(54) NETWORKED LOTTERY

(71) Applicant: IGT, Las Vegas, NV (US)

(72) Inventor: Sam Johnson, Las Vegas, NV (US)

(21) Appl. No.: 15/453,424

(22) Filed: Mar. 8, 2017

Related U.S. Application Data
(63) Continuation of application No. 11/470,254, filed on Sep. 6, 2006.

(51) Int. Cl. G07F 17/32

(52) U.S. Cl. CPC G07F 17/329; G07F 17/3225

(57) ABSTRACT

A network based lottery gaming system that generates or receives lottery entries as users perform certain actions. The numbers are identified with the users and collected over a period of time—the game interval. At the conclusion of the game interval, the collected entries are compared to a winning entry to identify if and who the winners are. Awards can be generated and paid out to the winners based on a payout table.

### PRIORITY CLAIM

This application is a continuation of, claims the benefit of and priority to U.S. patent application Ser. No. 11/470,254, filed on Sep. 6, 2006, the entire contents of which is incorporated by reference herein.

### BACKGROUND OF THE INVENTION

The present invention relates generally to both the gaming industry and telephone and/or network technology and, more particularly, to providing a lottery system based on sequences entered or generated by participants utilizing the network for performing and action such as placing a call on a telephony network or concluding an online transaction using the Internet.

Years ago, the word “churn” would conjure up wonderful visions of a motherly woman, working away over a clay pot, making butter for her family. Today, the mention of the word is quite different, especially for those in the communications industry. The word “churn” to a telecommunications service provider causes a cold, tingly feeling to run up and down their spine and causes the hairs on their neck to stand-up. In the telecommunications industry, churn refers a customer leaving one service provider and transitioning to another. The telecommunications industry is constantly looking for techniques to reduce their churn rate.

Some techniques that have been employed to reduce churn include providing financial incentives such as discounts and free services, the addition of new features, and upgrading equipment. Although these techniques, as well as other techniques have been instrumental in reducing churn, service provider companies are still in need of new and innovative techniques for reducing churn. Thus, there remains in the telecommunications industry a need for new and innovative techniques to decrease churn.

Churn is especially evident in the cellular telephone industry. Cellular service providers offer free minutes, roll-over minutes, free telephone upgrades and feature rich packages in an effort to attract and retain customers. Along with the churn issue, the cellular industry also faces another challenge—maximizing minute usage. Because cellular service providers generate revenue based on the number of minutes of talk time of their customers, the service providers are very motivated to increase the minute usage of their customer base. Increasing the minutes of usage of a cellular telephone service subscriber really includes two facets. One facet is focused on lengthening the duration of telephone calls and the other is focused on increasing the number of telephone calls. Thus, there is a need in the art for a technique to provide an incentive to cellular telephone customers that will discourage churn and encourage the users to place more calls and/or to extend the length of their calls.

Furthermore, when you look at a cellular telephone from a systems perspective, one realizes that a cellular telephone is actually a two-way radio and a computer. Because of this particular structure, cellular telephones have migrated into complex devices combining widely divergent technologies, such as MP3 players, cameras, personal assistants, Internet browsers, email applications, game platforms, and the like, with the cellular telephone technology. This has resulted in opening a wide array of techniques that can be employed to reduce churn and increase the number of usage minutes for cellular service subscribers.

The concept of churn can also be applied in many other settings other than telecommunications settings. For instance, online merchants greatly desire the attraction of customer traffic. For instance, online merchants such as EBAY, AMAZON.COM, OVERSTOCK.COM and many others could benefit from a technique that would encourage consumers to use their site and to return to their site next time a transaction is desired.

### SUMMARY OF THE INVENTION

The present invention provides a solution to the above-described needs in the art and other needs in the art by providing a lottery like gaming environment for telecommunication subscribers. In general, telecommunication service subscribers that opt in or are provided service in accordance with the present invention, create entries into the lottery like game by performing certain actions. For instance, in one embodiment of the present invention, the action could be an action completely independent from the lottery game and common for standard usage of the service (i.e., dialing a telephone number). In another embodiment of the invention, the subscriber may take specific actions that are related to or directed towards generating lottery entries. In either case, the subscriber generates an entry into the lottery game.

Entries are collected by the system for a period of time and then a drawing is performed. While collecting the entries, each entry collected is associated with the identity of the subscriber and then stored for later reference. When the game period expires, a winning sequence is identified and then compared to the entries into the game. If there is a match, the winners are provided an award. The award is typically based on a predefined payout table. The winning sequence can be generated randomly from the total domain of possible outcomes or, in some embodiments, may be generated from the domain of recorded entries randomly selected. In this latter embodiment, each lottery event can be guaranteed to produce at least one winner.

These and other aspects, features and embodiments of the present invention are more fully described in the detailed description that follows.

### BRIEF DESCRIPTION OF DRAWINGS

FIG. 1 is a system diagram illustrating a generic environment in which embodiments of the present invention can be deployed.

FIG. 2 is a flow diagram illustrating the steps involved in one embodiment of the present invention.

FIG. 3 is a flow diagram illustrating the steps involved in a cellular based embodiment of the present invention.

### DETAILED DESCRIPTION

The present invention is directed towards a lottery-like game that can be utilized by telecommunication service providers to reduce churn and/or increase system usage. In addition, embodiments of the present invention can also be offered by non-telecommunication service providers simply as a promotional activity, revenue generator, recreation, etc. In general, the present invention is a lottery-like game that is coupled to a telecommunications system. The invention is a lottery-like game in that participants enter, select or generate entry sequences over a period of time. At the conclusion of the period of time, the entered sequences are compared to a winning sequence to determine if there are any winners and to identify who the winners are. A subscriber to the telecommunications system can enter, select or generate a sequence for the lottery-like game simply by performing standard and expected operations with the telecommunications equipment, or by performing non-standard, game-specific activities. For instance, a standard and expected operation in a cellular telephone based telecommunications system would be the dialing of a destination telephone number. On the other hand, a non-standard, game-specific activity may include entering a sequence of digits after being prompted by the telephone display or the telecommunications system. A period of time is defined for the entry of sequences. Upon the expiration of the period of time, either one of the entered sequences is selected as a winning sequence or, a random sequence is generated and compared to the entered sequences to identify a winner. A payout table can be utilized to establish the winning criteria and the awards to winners.

Now turning to the figures, further details, aspects, embodiments and features of the present invention are described in more detail.

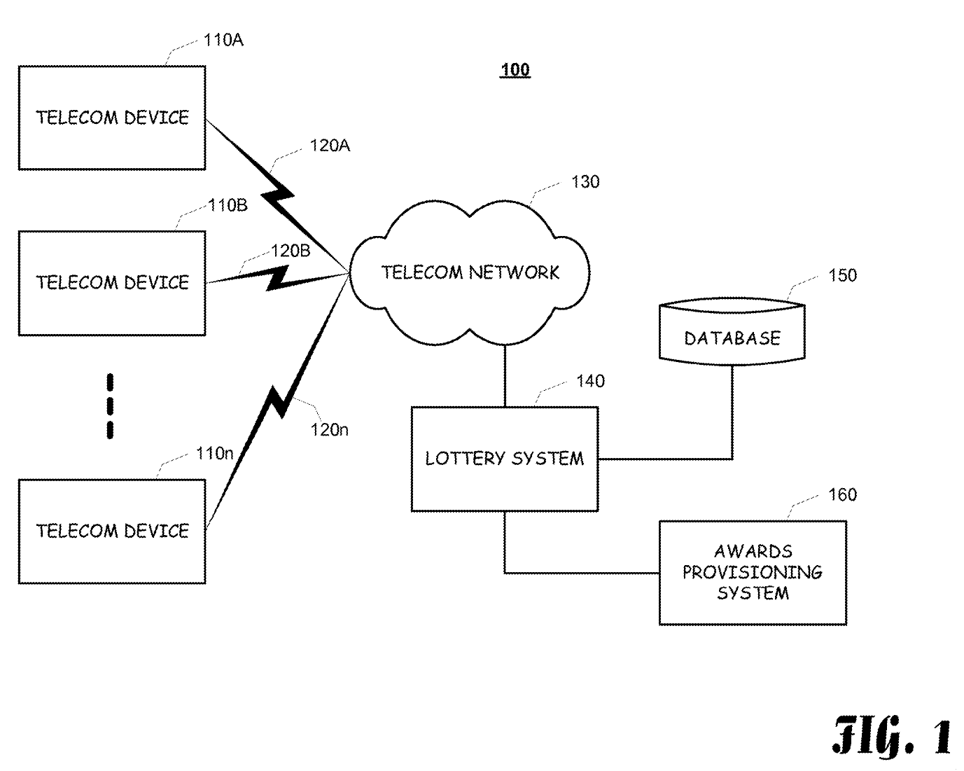

FIG. 1 is a system diagram illustrating a generic environment in which embodiments of the present invention can be deployed. The environment 100 is a telecommunications system that includes one or more end-user devices 110A-110n that are communicatively coupled to the telecommunications network infrastructure 130 through communication channels or media 120A-120n. A lottery system 140 is also coupled to the telecommunications network infrastructure. The lottery system 140 interfaces to a database 150 or other memory system or device for providing data storage and optionally an awards provisioning system 160.

It will be appreciated that the generic environment can represent a variety of specific environments such as the public switched telephone network (PSTN), a cellular telephone network, a voice over IP (VOIP) network, a data network, an email-centric network, or the like. Further, it will be appreciated that the telecommunications network cloud 130 may represent a combination of two or more similar and very different network types. For instance, the lottery system 140 may interface to the PSTN infrastructure, a cellular infrastructure and a VOIP infrastructure. Thus, the telecommunication cloud 130 may represent multiple infrastructures or the lottery system 140 may be connected to multiple network clouds 130.

The end-user telecommunication devices 110 can include a variety of devices such as, telephones, cellular handsets, personal data assistances, personal computers, two-way pagers, proprietary devices, or the like.

In the preferred embodiment, the telecommunication devices are used to gain communicative access to another device, either within or without the same telecommunications network. Communicative access is obtained by entering a destination address into the telecommunications device and transmitting a request for connection to the destination address to the telecommunications network. For instance, in a PSTN based embodiment, the telecommunication devices will typically be telephone units. Entering the destination address in this embodiment includes dialing the destination telephone number using the telephone unit. As the number is dialed, or after completion of dialing, signals are transmitted to the telecommunications network as a request to setup a connection to the destination number. In a cellular telephone system based embodiment, the destination number is transmitted as a connection request command to the mobile switching office. In an Internet based embodiment, the communicative access can be obtained by entering an IP address or URL into a browser application or by sending a VOIP connection request identifying the destination. In an email system embodiment, communication access is obtained by placing a destination address into the email and transmitting the email message to the email server. It will be appreciated, that these examples are provided only as non-limiting examples to help illustrate the general characteristics of the present invention.

Embodiments of the present invention operate to capture or gain access to the destination addresses that are submitted to gain access through the telecommunications network. The identity of the party or the source of the destination number is also obtained and stored into the database by the lottery system 140 along with the destination number. Thus, non-limiting examples of the destination addresses may include telephone numbers, portions of telephone numbers, email addresses, mobile identification numbers, IP addresses, or the like. It should also be appreciated that the entry sequences may only be based on a destination address. For instance, the destination address could be used as a seed to a random number generator. In addition, other information could be used as, or to generate, the entry sequence. For instance, the time of day and/or the date that a connection request is made may be used to generate an entry sequence. Furthermore, the simple action of making a connection request may simply be used to trigger the generation of a random number. Those skilled in the art will also appreciate that other techniques may be used. For instance, the timing between key presses of a user could be used as input to a random number generation. In addition, a user may be requested or prompted by the telecommunications system to enter a sequence using the keyboard. Another technique would be to take digital samples of any voice signals that may be detected on the communications line. These digital samples could be used to directly convert over to a random number or may be used as a seed to a random number generator. Thus, a variety of techniques may be used to generate the entry sequences and although one or more of the described techniques may in and of itself be considered a novel aspect of the present invention, the present invention is not to be limited to any particular technique.

The lottery system 140 collects the destination addresses (or entry sequences) from the telecommunications system 130 for a finite period of time. For instance, the lottery may run daily, hourly, weekly, monthly, etc. Once the period of time is up, the collected destination addresses are used as the domain of lottery entries. In one embodiment, a winning sequence is randomly generated and then compared to the collected destination addresses. Depending on the similarity between the winning sequence and each collected destination address, an award may be granted. For instance, in one embodiment, only an exact match will result in generation an award. In another embodiment, graduated awards may be presented based on the proximity of the match. For instance, one award may be provided for an exact match and a reduced award may be provided in all but one of the items in the sequence match the winning sequence. It will be appreciated to those skilled in the art that various payout tables can be generated to define the awards available through the various embodiments of the present invention and the present invention should not be limited to any particular payout construction.

In some embodiments, an awards processing system 160 may be used to provision the award system. Such a system can operate to automatically contact the winning participants or to automatically generate awards.

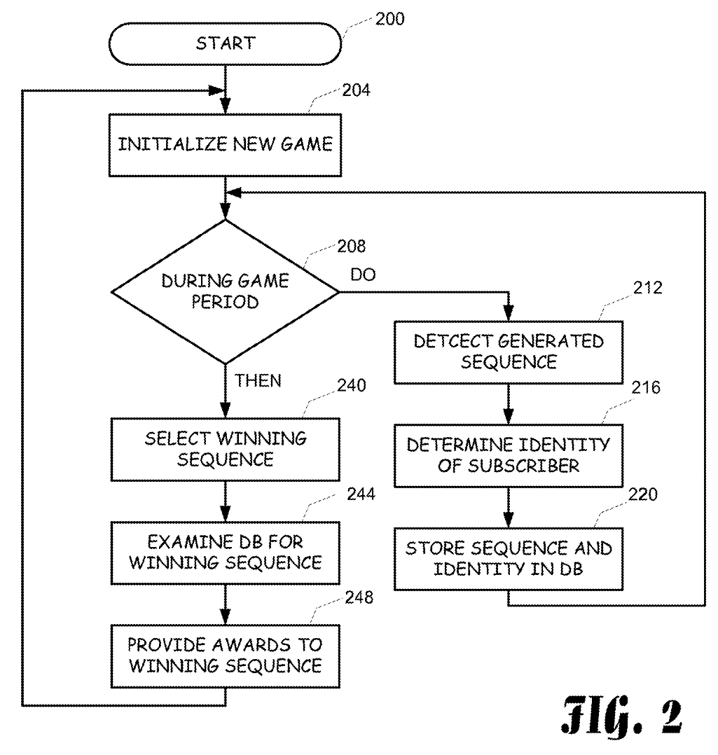

FIG. 2 is a flow diagram illustrating the steps involved in one embodiment of the present invention. The process 200 begins by the initialization of a new game. This process can include a variety of tasks, but in general, the tasks will at least include starting of a new period of time over which the lottery game will extend. Once the new game is initialized, the game begins. During the operational period of time for the lottery game 208, the process operates to detect when a sequence is generated 212. Once the sequence generation is detected, the identity that is associated with the generated sequence is identified 216. The generated sequence and the identity of the associated party are stored into memory 220. This process continues until the lottery game is over. Thus far, the duration of the lottery game has been described as being time based. However, those skilled in the art will appreciate that the duration of the lottery game may also be event based. For instance, the lottery game may continue until a certain number of entries are collected. Alternatively, the lottery game may generate a winning sequence at the onset and continue until the winning sequence is collected. Furthermore, the duration of the lottery may be tied to other events occurring the various embodiments of the invention my employ such defining events.

Once the duration of the lottery game is concluded, the process continues by selecting a winning sequence 240. It should be appreciated that the winning sequence can be selected at anytime in this process but it is being portrayed as generated chronologically at this point simply as a non-limiting example. The winning sequence can be selected by generating a random number, or can be generated using some other means such as selecting a particular sequence from the domain of possible sequences. In addition, in some embodiments, the winning sequence may be selected directly from collected generated sequences—thereby guaranteeing a winner. However, in the illustrated embodiment, a winning sequence is selected and then compared to the stored generated sequences 244. Based on the results of this comparison, awards may be granted to the winning entries 248. Processing may then return to step 204 to initialize the beginning of another lottery game.

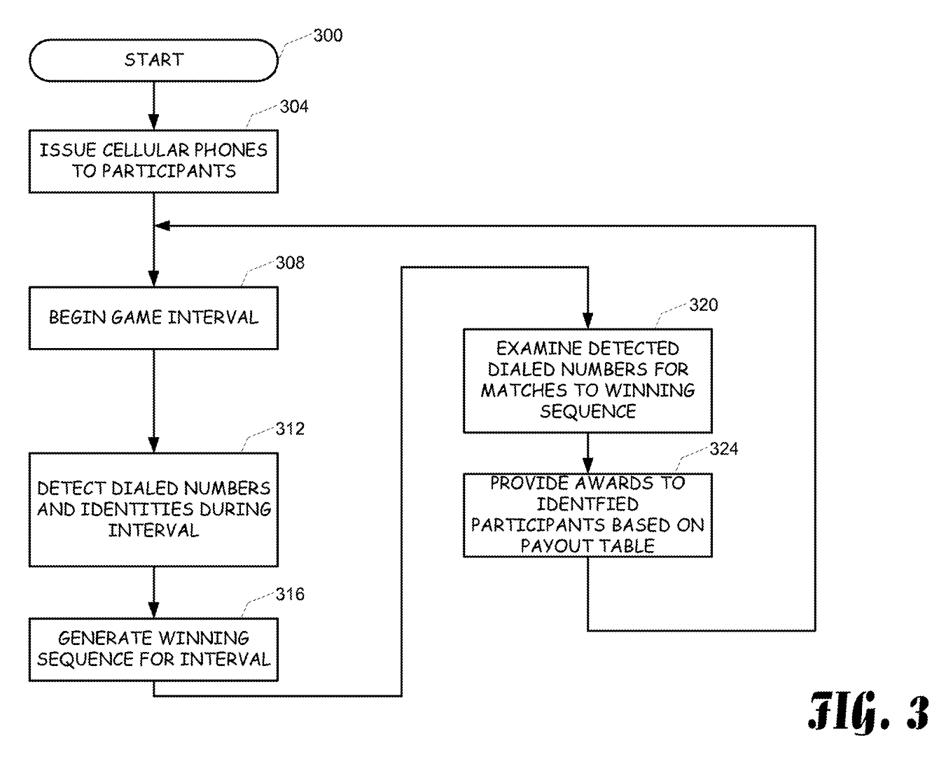

FIG. 3 is a flow diagram illustrating the steps involved in a cellular based embodiment of the present invention. The illustrated embodiment is a specific, non-limiting example of a particular embodiment of the present invention that can be used to limit churn and increase minute usage in a cellular system. It should be appreciated that although the illustrated embodiment may in and of itself be novel, the present invention is not necessarily limited to this particular embodiment.

The process 300 begins by a cellular service provider provisioning one or more subscribers with cellular telephones to be used on the provider's cellular system 304. This process may include running a special for new subscribers, or can be offered to existing subscribers or a combination of both. In either case, particular cellular subscribers are identified as being participants in the lottery event. Once the participants are identified and provisioned, the game interval commences 308. During the active period of the game, numbers that are dialed by the participating subscribers using the cellular system are detected and maintained along with the identity of the subscriber 312. In addition, a winning sequence for the particular gaming interval is also generated 316. Once the gaming interval is over, the dialed numbers are examined and compared to the winning sequence to determine if there are any winners (i.e., matching sequences) 320. If a dialed number qualifies for an award based on a comparison with the winning sequence, the award is provided to the subscriber associated with the dialed number 324. The process can then continue at step 308 with a new gaming interval. Alternatively, the process can continue at step 304 to allow additions or deletions of the pool of participants. In another embodiment, processing can continue at step 316 to generate another winning sequence. In this embodiment, multiple winners can be identified or, if there were no winners using the first winning sequence, a new winning sequence can be generated. This process can be repeated until a winner is identified.

More specifically, the illustrated embodiment can operate to capture every telephone call made by a participant and automatically enter the 7 digits (or 10 digits) that were dialed into the lottery drawing. The drawing takes place periodically, such as once every night or some other frequency (or even instantly). The outcome of the drawing will be determined based on the telephone call or telephone calls made between each drawing. Similar to other lotteries and/or sweepstakes, prizes are paid against a given pay table. Thus, if you hit 3 of the 7 digits you win $X, 4 of the 7 digits $Y and 7 of the 7 digits awards the jackpot.

Throughout the present description, the term “entered sequence” and “winning sequence” has been used. It should be appreciated that these sequences can take on a variety of forms. In one embodiment, the sequences can simply be a 7 or 10 digit telephone number. However, it should be appreciated that this is a non-limiting example and the sequence can simply be a single value, an integer, a value generated through a analog to digital conversion, an output of a random number generated, a series of characters, a series of glyphs, etc. It should be appreciated that a glyph is defined as any symbol or character, whether it is a letter, number, punctuation mark, graphic or other displayable element.

It should also be appreciated that the present invention can be incorporated into other types of systems that are not typically considered telecommunications systems. For instance, the present system could be employed in a point-of-sale environment. In such an embodiment, each time a receipt is issued to a customer (i.e., when ever a customer makes a purchase) an entry sequence can be generated either randomly, based on the invoice or receipt number of any of a variety of other information. These entry sequences can then be entered into the lottery game. Similarly, the present invention can be incorporated into an online transaction, such as EBAY or ITUNES. In such an embodiment, when a transaction is conducted (i.e. winning a bid on EBAY or downloading a song from ITUNES), a sequence can be entered or generated and entered into the lottery game for the next drawing. Similarly, the present invention could be used in information based Internet services such as mapping services, weather services, news services, etc. Each time a user accesses a particular web site, and entry for the lottery may be generated. Likewise, each time the user actuates and application available on a website, such as generating driving directions on MAPQUEST, an entry in the lottery may be generated.

In the description and claims, each of the verbs, “comprise” “include” and “have”, and conjugates thereof, are used to indicate that the object or objects of the verb are not necessarily a complete listing of members, components, elements or parts of the subject or subjects of the verb.

The present invention has been described using detailed descriptions of embodiments thereof that are provided by way of example and are not intended to limit the scope of the invention. It will be appreciated that other uses of the present invention are also anticipated. The described embodiments comprise different features, not all of which are required in all embodiments of the invention. Some embodiments of the present invention utilize only some of the features or possible combinations of the features. The scope of the invention is limited only by the following claims.

The invention is claimed as follows:

1. A gaming system comprising:
an input device,
a display device,
a processor; and
a memory device which stores a plurality of instructions, which when executed by the processor, cause the processor to:
enable a player to place, via the input device, a wager on a play of a game, and
for the wagered on play of the game:
randomly determine a game outcome, said random determination being based, at least in part, on data selected from the group consisting of: data associated with an email address, data associated with a mobile phone number, and data associated with an internet protocol address,
cause the display device to display the randomly determined game outcome,
determine any award associated with the randomly determined game outcome, and
cause the display device to display any determined award associated with the randomly determined game outcome.

2. The gaming system of claim 1, wherein the randomly determined game outcome comprises an entry sequence of a lottery.

3. The gaming system of claim 1, wherein the data associated with the email address comprises an email address of the player, and the data associated with the internet protocol address comprises an internet protocol address visited by the player.

4. The gaming system of claim 1, wherein at least one number associated with the data selected from the group consisting of: data associated with the email address, data associated with the mobile phone number, and data associated with the internet protocol address seeds a random number generator associated with the random determination of the game outcome.

5. The gaming system of claim 1, which comprises an acceptor, wherein when executed by the processor, the plurality of instructions cause the processor to, responsive to a physical item being received via the acceptor, establish a credit balance based, at least in part, on a monetary value associated with the received physical item, and responsive to a cashout input being received, cause an initiation of any payout associated with the credit balance.

6. A system comprising:
a processor; and
a memory device which stores a plurality of instructions, which when executed by the processor, cause the processor to:
detect an occurrence of an activity during a predefined period of time, wherein the activity is at least partially performed over a data network, the activity is independent of any request by a player to obtain an entry for a lottery game, and said data network is distinct from a telephone network,
responsive to the detection of the occurrence of the activity:
determine an entry sequence for the lottery game, and
associate the determined entry sequence with the player, and
after the predefined period of time, for each determined entry sequence associated with the player:
determine if said determined entry sequence is a winning sequence for the lottery game, and
responsive to determining that said determined entry sequence is the winning sequence for the lottery game:
determine an award for the lottery game, and
cause a display, by a display device, of the determined award for the lottery game.

7. The system of claim 6, wherein the activity comprises the player sending an email to an email address.

8. The system of claim 7, wherein said determined entry sequence for the lottery game is at least partially based on the email address.

9. The system of claim 6, wherein the activity comprises the player accessing an internet protocol address with a web browser.

10. The system of claim 9, wherein said determined entry sequence for the lottery game is at least partially based on the internet protocol address.

11. A system comprising:
a processor; and
a memory device which stores a plurality of instructions, which when executed by the processor, cause the processor to:
detect an occurrence of an activity during a predefined period of time, wherein the activity is selected from the group consisting of: a point-of-sale transaction and an online transaction and the activity is independent of any request by a player to obtain an entry for a lottery game,
responsive to the detection of the occurrence of the activity:
determine, based on data associated with the activity, an entry sequence for the lottery game, and
associate the determined entry sequence with the player, and
after the predefined period of time, for each determined entry sequence associated with the player:
determine if said determined entry sequence is a winning sequence for the lottery game, and
responsive to determining that said determined entry sequence is the winning sequence for the lottery game:
determine an award for the lottery game, and
cause a display, by a display device, of the determined award for the lottery game.

12. The system of claim 11, wherein the data associated with the activity is selected from the group consisting of: an invoice number and a receipt number.
